(19) United States
(12) Patent Application Publication
(10) Pub. No.: US 2010/0014396 A1
(43) Pub. Date: Jan. 21, 2010

(54) DRIVE APPARATUS, DRIVE METHOD, PROGRAM, AND RECORDING MEDIUM

(75) Inventor: Takashi NAGATOMO, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, TOKYO (JP)

(21) Appl. No.: 12/475,696

(22) Filed: Jun. 1, 2009

(30) Foreign Application Priority Data
Jul. 17, 2008 (JP) 2008-186096

(51) Int. Cl. G11B 20/00

(52) U.S. Cl. 369/47.15; G9B/20

(57) ABSTRACT

A drive apparatus includes n optical pickups, n control units, each controlling a corresponding one of the n optical pickups, and a communication unit that allows the n control units to communicate with one another.

### BACKGROUND OF THE INVENTION

1. Field of the Invention

The present invention relates to a drive apparatus, a drive method, a program, and a recording medium and, in particular, to a drive apparatus, a drive method, a program, and a recording medium that increase the speed of recording and reproducing operations on a predetermined disk.

2. Description of the Related Art

In recent years, recording and reproducing of a high-quality image data have been in widespread use. The amount of data for such a high-quality image tends to increase. Accordingly, when data is recorded, the amount of data written into a predetermined disk increases, and therefore, it is necessary that the writing speed is increased. A method for increasing the writing speed by increasing the rotation speed of a spindle is developed.

However, if the rotation speed of a spindle is increased, noise caused by rotation of the spindle increases, and therefore, the noise may be recorded. For this reason, an increase in recording speed by increasing the rotation speed of the spindle is not desirable. In addition, when the recording speed is increased by increasing the rotation speed of the spindle, the following limitations appear: a limitation of a recording data rate due to the characteristic of a disk medium, a limitation of processing power of a signal processing LSI, and a physical limitation of rotating a disk at high speed.

Accordingly, the channels of two optical systems having the same specification can be provided, and a recording operation can be performed using the two channels. In apparatuses having two channels, the two channels can be disposed so as to face each other, and each of the two channels can include a slider. In such a configuration, the channels can be independently controlled in a sliding manner and can simultaneously perform a recording operation on the predetermined disk. As a result, the recording speed can be increased (refer to, for example, Japanese Unexamined Patent Application Publication No. 2005-276405).

### SUMMARY OF THE INVENTION

When a recording operation and a reproducing operation are performed using two channels and if each of the devices (e.g., the integrated circuits (ICs)) used for a disk drive have single function, the apparatus can be configured from two signal processing devices, a digital signal processor (DSP) servo, and one central processing unit (CPU) that controls the signal processing devices and the DSP servo. However, such a configuration increases consumption power and a manufacturing cost.

Accordingly, in order to reduce consumption power and a manufacturing cost, the signal processing devices can be integrated into one chip that includes a CPU and a DSP servo. However, such a configuration optimizes the two devices for control of only one optical pickup. Therefore, it is difficult to optimize the two devices for control of two optical pickups.

Accordingly, the present invention provides a drive apparatus, a drive method, a program, and a recording medium capable of optimally controlling two optical pickups.

According to an embodiment of the present invention, a drive apparatus includes n optical pickups, n control means, each controlling a corresponding one of the n optical pickups, and communication means for allowing the n control means to communicate with one another.

Each of the control means can be made from the same type of LSI.

First control means of the n control means can receive an instruction to turn on or off servo control, and, upon receiving the instruction to turn on or off servo control, the first control means can send, to another control means, information indicating the reception of the instruction.

The n control means can be supplied with an FG signal from a spindle motor, and first control means of the n control means can control the spindle motor.

Upon receiving a seek request, first control means of the n control means can send information indicating the reception of the seek request to second control means different from the first control means. Upon receiving the information, the second control means can determine whether a seek operation is available. If the seek operation is available, the second control means can send, to the first means, information indicating that the seek operation is allowed. Upon receiving the information indicating that the seek operation is allowed, the first control means can start the seek operation.

It can be determined that the seek operation is available if the second control means performs no processing or a RUB Address of a target seek position is located within a range defined by a RUB address at which the optical pickup controlled by the second control means is located ±2048 RUB Addresses.

Upon receiving an SP Target update request, first control means of the n control means can send information indicating the reception of the SP Target update request to a second control means different from the first control means. Upon receiving the information, the second control means can determine whether an SP Target update operation is available and can send, to the first control means, information indicating a determination result. Upon receiving the information indicating the determination result, the first control means can start processing in accordance with the determination result.

It can be determined that the SP Target update operation is available if the second control means performs no processing or a RUB Address of an SP Target update position is located within a range defined by a RUB address at which the optical pickup controlled by the second control means is located ±2048 RUB Addresses.

If the determination result received from the second control means indicates that the update of the SP Target is not allowed, the first control means can stop processing, and, if the determination result received from the second control means indicates that the update of the SP Target is allowed, the first control means can update the SP Target to the SP Target requested by the first control means. When the determination result received from the second control means indicates that the update of the SP Target is allowed and if the determination result includes an address at which the optical pickup controlled by the second control means is located, the first control means can update the SP Target to an address at which, of the two optical pickups controlled by the second control means and the first control means, the optical pickup located on the inner periphery side is located.

Here, n can be 2, and two optical pickups are mounted in one optical head.

According to another embodiment of the present invention, a method for driving a drive apparatus is provided. The drive apparatus includes n optical pickups, n control means, each controlling a corresponding one of the n optical pickups, and communication means for allowing the n control means to communicate with one another. The method includes the step of controlling communication performed by the communication means so that, when a recording or reproducing operation is performed by the n optical pickups, information is exchanged among the n control means, and the n optical pickups are capable of cooperating.

According to still another embodiment of the present invention, a computer-readable program is provided. The computer-readable program includes program code for causing a drive apparatus including n optical pickups, n control means, each controlling a corresponding one of the n optical pickups, and communication means for allowing the n control means to communicate with one another to execute the step of controlling communication performed by the communication means so that, when a recording or reproducing operation is performed by the n optical pickups, information is exchanged among the n control means, and the n optical pickups are capable of cooperating.

According to still yet another embodiment of the present invention, a recording medium is provided. The recording medium stores a computer-readable program for causing a drive apparatus including n optical pickups, n control means, each controlling a corresponding one of the n optical pickups, and communication means for allowing the n control means to communicate with one another to execute the step of controlling communication performed by the communication means so that, when a recording or reproducing operation is performed by the n optical pickups, information is exchanged among the n control means, and the n optical pickups are capable of cooperating.

In the drive apparatus, the method for driving a drive apparatus, the computer-readable program, and the recording medium according to the embodiments of the present invention, n optical pickups cooperate in order to perform recording and reproducing operations. At that time, necessary information is exchanged among the control means that control the n optical pickups.

According to the above-described embodiments of the present invention, two optical pickups can be optimally controlled.

### BRIEF DESCRIPTION OF THE DRAWINGS

FIG. 1 is a diagram illustrating an exemplary configuration of a drive apparatus according to an embodiment of the present invention;

FIG. 2 is a diagram illustrating another exemplary configuration of the drive apparatus according to the embodiment of the present invention;

FIG. 3 illustrates control of a spindle motor;

FIG. 4 illustrates an exemplary internal configuration of the drive apparatus;

FIG. 5 illustrates tasks;

FIG. 6 illustrates tasks;

FIG. 7 is a flowchart illustrating an exemplary operation performed by the drive apparatus;

FIG. 8 is a flowchart illustrating an exemplary operation performed by the drive apparatus;

FIG. 9 is a diagram illustrating a packet;

FIGS. 10A to 10C are diagrams illustrating packets;

FIG. 11 illustrates various tasks;

FIG. 12 is a flowchart illustrating an exemplary operation performed by the drive apparatus;

FIG. 13 is a flowchart illustrating an exemplary operation performed by the drive apparatus;

FIGS. 14A and 14B are diagrams illustrating packets;

FIG. 15 is a diagram illustrating a limitation of the operation;

FIGS. 16A and 16B illustrate a seek operation;

FIGS. 17A and 17B illustrate a seek operation;

FIG. 18 illustrates tasks;

FIG. 19 is a flowchart illustrating an exemplary operation performed by the drive apparatus;

FIG. 20 is a flowchart illustrating an exemplary operation performed by the drive apparatus;

FIG. 21 is a flowchart illustrating an exemplary operation performed by the drive apparatus;

FIG. 22 is a diagram illustrating a packet; and

FIG. 23 is a diagram illustrating a recording medium.

### DESCRIPTION OF THE PREFERRED EMBODIMENTS

Various exemplary embodiments of the present invention are described below with reference to the accompanying drawings.

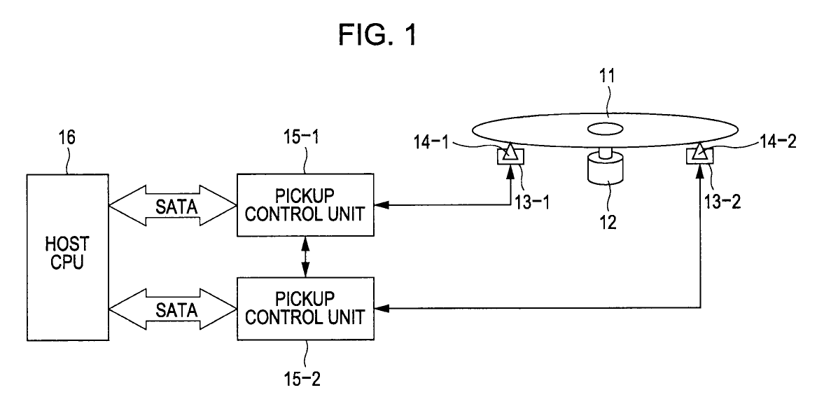

FIG. 1 illustrates an exemplary configuration of a drive apparatus according to an embodiment of the present invention. According to the present embodiment, an apparatus for driving a predetermined disk and recording and reproducing data on and from the disk is provided.

As shown in FIG. 1, the drive apparatus drives a disk 11 representing a predetermined disk. Examples of the disk 11 include a digital versatile disc (DVD) and a Blu-ray Disc (BD). The drive apparatus includes a spindle motor 12, an optical head 13-1, an optical head 13-2, an optical pickup 14-1, an optical pickup 14-2, a pickup control unit 15-1, a pickup control unit 15-2, and a host central processing unit (CPU) 16.

Hereinafter, when distinction between the optical heads 13-1 and 13-2 is unimportant, each of the optical heads 13-1 and 13-2 is simply referred to as an “optical head 13”. This notation is also applied to the other components.

As shown in FIG. 1, the drive apparatus includes the two optical heads 13-1 and 13-2. The optical head 13-1 includes the optical pickup 14-1. The optical head 13-2 includes the optical pickup 14-2. The optical head 13-1 (the optical pickup 14-1) is controlled by the pickup control unit 15-1. The optical head 13-2 (the optical pickup 14-2) is controlled by the pickup control unit 15-2.

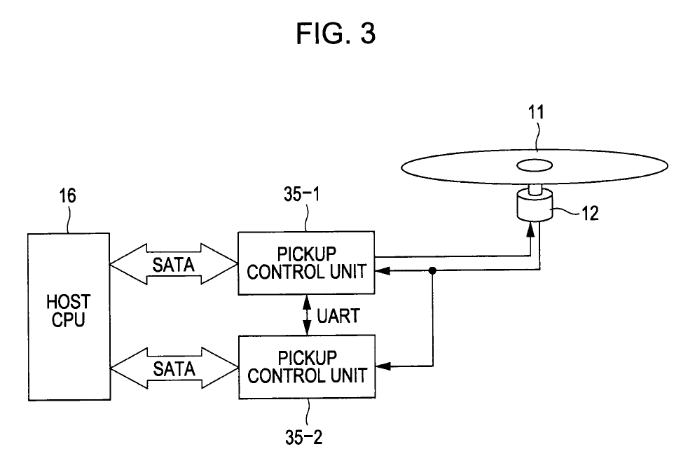

However, the optical head 13-1 (the optical pickup 14-1) and the optical head 13-2 (the optical pickup 14-2) are desired to operate in cooperation with each other, e.g., to simultaneously write data. Accordingly, a signal that allows the optical heads 13-1 and 13-2 to cooperate is exchanged therebetween. As illustrated in FIG. 3, it is necessary that the spindle motor 12 is controlled by only one of the pickup control units 15-1 and 15-2. Therefore, the drive apparatus is configured so that only one of the pickup control units 15-1 and 15-2 controls the spindle motor 12.

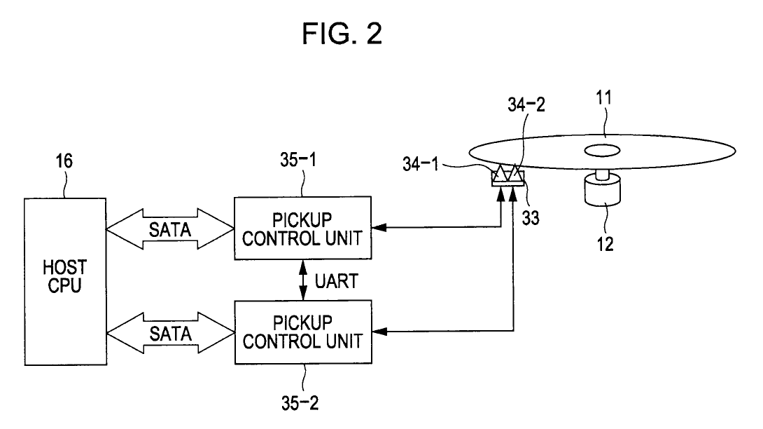

FIG. 2 illustrates a different configuration of the drive apparatus according to an embodiment of the present invention. Like the drive apparatus shown in FIG. 1, the drive apparatus shown in FIG. 2 drives the disk 11 representing a predetermined disk. As shown in FIG. 2, the drive apparatus includes the spindle motor 12, an optical head 33, an optical pickup 34-1, an optical pickup 34-2, a pickup control unit 35-1, a pickup control unit 35-2, and the host CPU 16.

In the drive apparatus shown in FIG. 2, the optical head 33 includes the two optical pickups 34-1 and 34-2. The optical pickup 34-1 is controlled by the pickup control unit 35-1. The optical pickup 34-2 is controlled by the pickup control unit 35-2. In such a configuration, the optical head 33 is controlled by one of the pickup control units 35-1 and 35-2. In addition, like the drive apparatus shown in FIG. 1, the spindle motor 12 is controlled by only one of the pickup control units 35-1 and 35-2.

Furthermore, like the drive apparatus shown in FIG. 1, the drive apparatus shown in FIG. 2 is configured so that a signal can be exchanged between the pickup control units 35-1 and 35-2, and the pickup control units 35-1 and 35-2 can operate in cooperation with each other.

FIG. 3 illustrates control of the spindle motor 12 in the drive apparatus shown in FIG. 1 or 2 (the drive apparatus shown in FIG. 2 in this example). Rotation of the disk 11 is controlled by the spindle motor 12. A signal that controls the rotation is supplied from the pickup control unit 35-1. The spindle motor 12 supplies a frequency generator (FG) signal indicating the rotation speed to the pickup control units 35-1 and 35-2.

Each of the pickup control units 35-1 and 35-2 uses the FG signal for controlling the optical pickup 34. Accordingly, the FG signal is supplied to each of the pickup control units 35-1 and 35-2. If it is determined that the pickup control unit 35-1 controls the spindle motor 12, the pickup control unit 35-1 generates the signal for controlling the spindle motor 12 and supplies the generated signal to the spindle motor 12.

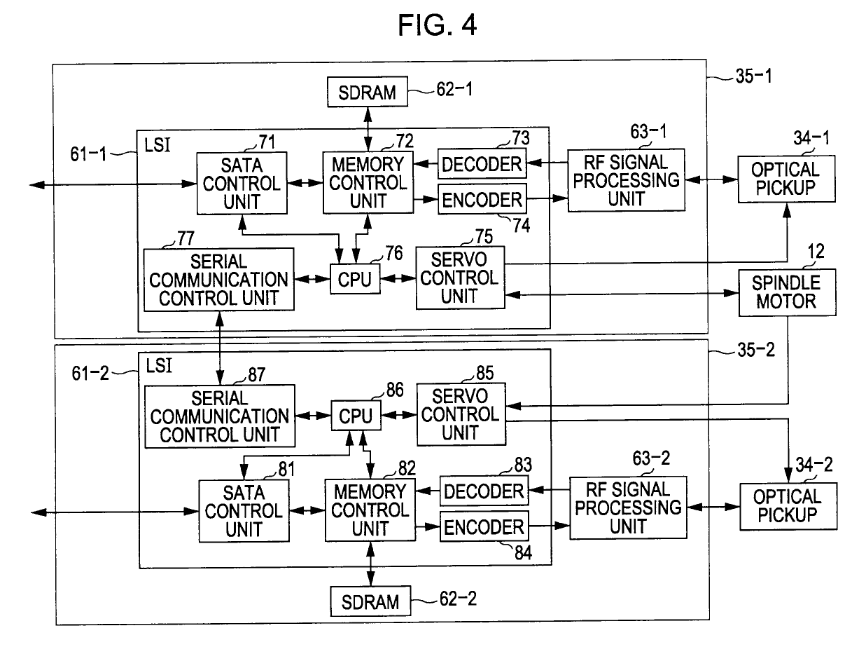

FIG. 4 illustrates an exemplary internal configuration of the drive apparatus shown in FIG. 2. While the drive apparatus shown in FIG. 2 is described in this example, even a drive apparatus including two optical head 13 each having an optical pickup 14, like the drive apparatus shown in FIG. 1, has a similar internal configuration.

The pickup control unit 35-1 includes a large scale integration (LSI) 61-1, a synchronous dynamic random access memory (SDRAM) 62-1, and a radio frequency (RF) signal processing unit 63-1. The LSI 61-1 includes a serial advanced technology attachment (SATA) control unit 71, a memory control unit 72, a decoder 73, an encoder 74, a servo control unit 75, a CPU 76, and a serial communication control unit 77.

Similarly, the pickup control unit 35-2 includes an LSI 61-2, an SDRAM 62-2, and an RF signal processing unit 63-2. The LSI 61-2 includes an SATA control unit 81, a memory control unit 82, a decoder 83, an encoder 84, a servo control unit 85, a CPU 86, and a serial communication control unit 87.

The pickup control unit 35-1 controls the optical pickup 34-1. The pickup control unit 35-1 supplies data to the optical pickup 34-1 and receives data from the optical pickup 34-1. When data is reproduced, data output from the optical pickup 34-1 is supplied to the decoder 73 of the LSI 61-1 via the RF signal processing unit 63-1. The decoder 73 decodes the supplied data using a predetermined decoding method and supplies the decoded data to the memory control unit 72.

Under the control of the CPU 76, the memory control unit 72 stores the supplied data in the SDRAM 62-1 or reads data stored in the SDPAM 62-1. The SDRAM 62-1 is used as a buffer.

When data is recorded, under the control of the memory control unit 72, data is read from the SDRAM 62-1 and is supplied to the encoder 74. The encoder 74 encodes the supplied data using a predetermined encoding method and supplies the encoded data to the optical pickup 34-1 via the RF signal processing unit 63-1.

The SATA control unit 71 controls communication with the host CPU 16 (see FIG. 2). The serial communication control unit 77 controls communication with the pickup control unit 35-2. That is, as noted above, it is necessary that the pickup control unit 35-1 and the pickup control unit 35-2 share the same information in order to cause the optical pickups 34-1 and 34-2 to operate in cooperation with each other. Communication necessary for sharing the information is controlled by the serial communication control unit 77. In addition, to perform this communication, the pickup control unit 35-1 and the pickup control unit 35-2 have two communication lines (two serial interfaces).

The servo control unit 75 controls servos, such as a focusing servo and a tracking servo of the optical pickup 34-1 (the optical head 33). In addition, the servo control unit 75 controls the rotation of the spindle motor 12.

Like the pickup control unit 35-1, the pickup control unit 35-2 controls the optical pickup 34-2 in order to control recording and reproduction operations. However, unlike the servo control unit 75 of the pickup control unit 35-1, the servo control unit 85 of the pickup control unit 35-2 receives an FG signal from the spindle motor 12, but outputs no control signals to the spindle motor 12.

As described above, the pickup control unit 35-1 and the pickup control unit 35-2 each controlling the optical pickup 34 have a similar configuration and perform a similar operation. However, only the pickup control unit 35-1 controls the spindle motor 12. Such a configuration allows the two pickup control units to employ the same type of an LSI, and therefore, the manufacturing cost can be advantageously reduced. In addition, by providing the serial communication control unit 77 (87) for sharing information, the two pickup control units can advantageously cooperate with each other.

Furthermore, for example, an LSI widely used for drives of personal computers can be used for the above-described LSI. Such an LSI is relatively inexpensive. Accordingly, the cost of the entire drive apparatus can be reduced.

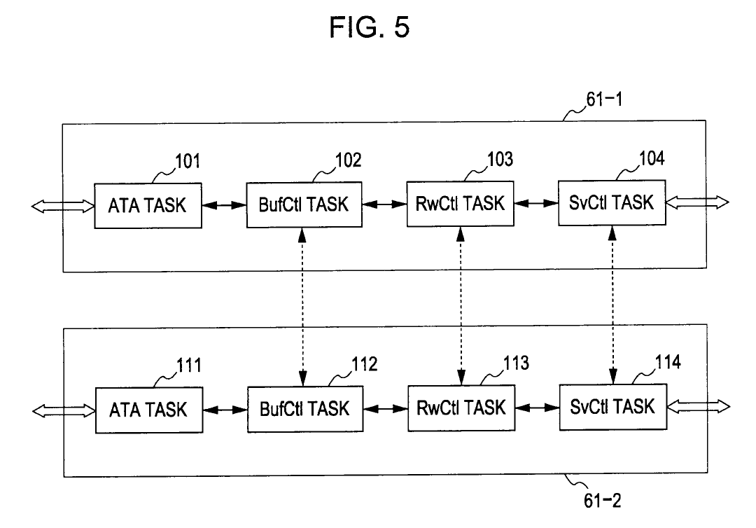

The software configuration is shown in FIG. 5 for the case in which the configuration of the drive apparatus shown in FIG. 4 is realized by software. The pickup control unit 35-1 includes an ATA TASK 101, a BufCtl TASK 102, an RwCtl TASK 103, and a SvCtl TASK 104. Similarly, the pickup control unit 35-2 includes an ATA TASK 111, a BufCtl TASK 112, an RwCtl TASK 113, and an SvCtl TASK 114.

The ATA TASK 101 controls the SATA control unit 71 so as to control reception of a command from the SATA interface and data transfer. The BufCtl TASK 102 controls the memory control unit 72 so as to control a buffer (e.g., Cache) of a drive. The RwCtl TASK 103 controls the decoder 73 and the encoder 74 so as to control data read and write operations from and to the disk 11. The SvCtl TASK 104 controls the servo control unit 75 so as to perform servo control of the optical pickup 34-1.

Similarly, the ATA TASK 111 controls the SATA control unit 81 so as to control reception of a command from the SATA interface and data transfer. The BufCtl TASK 112 controls the memory control unit 82 so as to control a buffer (e.g., Cache) of a drive. The RwCtl TASK 113 controls the decoder 83 and the encoder 84 so as to control data read and write operations from and to the disk 11. The SvCtl TASK 114 controls the servo control unit 85 so as to perform servo control of the optical pickup 34-2.

These tasks control the serial communication control unit 77 or the serial communication control unit 87 to perform communication when necessary. That is, the BufCtl TASK 102 and the BufCtl TASK 112 control the serial communication control unit 77 and the serial communication control unit 87, respectively, so as to communicate with each other. Similarly, the RwCtl TASK 103 and the RwCtl TASK 113 control the serial communication control unit 77 and the serial communication control unit 87, respectively, so as to communicate with each other. The SvCtl TASK 104 and the SvCtl TASK 114 control the serial communication control unit 77 and the serial communication control unit 87, respectively, so as to communicate with each other.

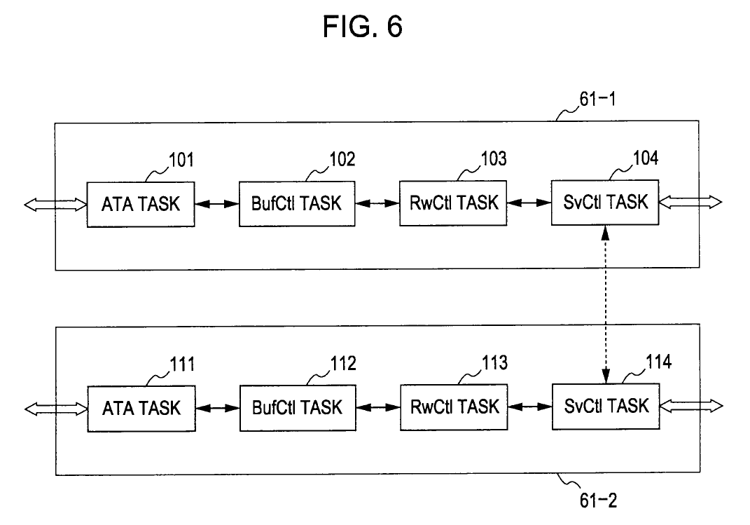

An exemplary operation of the drive apparatus is described next with reference to a particular example. First, the operations performed when the servo is turned on and off are described. The operations regarding the servo control is performed by the SvCtl TASK 104 and the SvCtl TASK 114. Accordingly, as shown in FIG. 6, in order to perform control, the SvCtl TASK 104 and the SvCtl TASK 114 perform communication (universal asynchronous receiver transmitter (UART) communication) so as to exchange information.

In addition, an instruction to turn on or off the servo is supplied from the host CPU 16. Thereafter, commands are exchanged among the ATA TASK 101, the BufCtl TASK 102, the RwCtl TASK 103, and the SvCtl TASK 104 in the LSI 61-1. Since turn-on or turn-off of the servo is controlled by the pickup control unit 35-1, the tasks in the pickup control unit 35-2 exchange no commands therebetween.

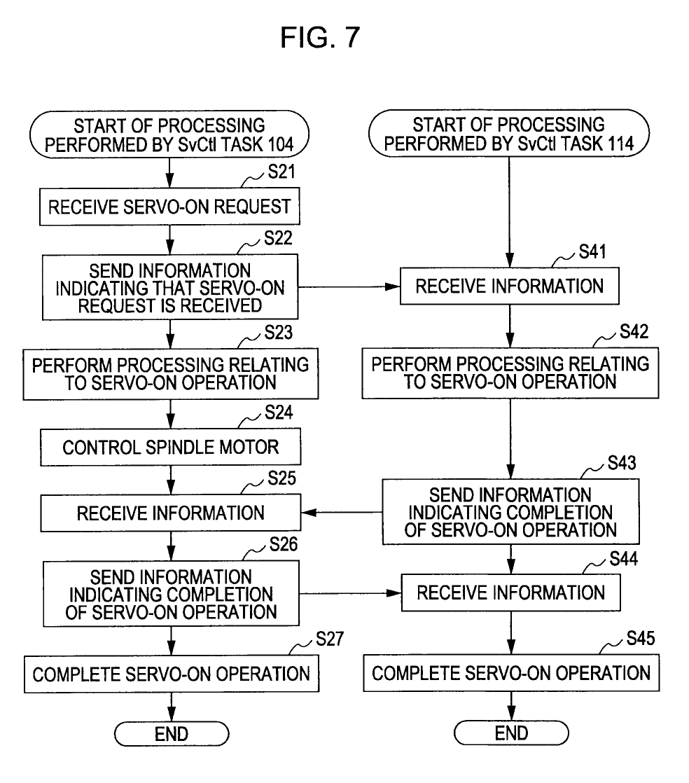

The operations performed by the SvCtl TASK 104 and the SvCtl TASK 114 when the servo is turned on are described next with reference to FIG. 7. In step S21, the SvCtl TASK 104 receives a request to turn on the servo. Upon receiving the request to turn on the servo, the SvCtl TASK 104, in step S22, sends, to the SvCtl TASK 114, information indicating that the servo turn-on request is received. That is, the CPU 76 controls the serial communication control unit 77 so as to send, to the pickup control unit 35-2, the information indicating that the servo turn-on request is received.

When, in step S41, the information sent from the serial communication control unit 77 is received by the serial communication control unit 87 of the pickup control unit 35-2, the CPU 86 analyzes the information and knows that it has received a servo turn-on request. In step S42, the CPU 86 performs processing relating to a servo-on operation. That is, the SvCtl TASK 114 performs processing relating to a servo-on operation.

Similarly, in step S23, the SvCtl TASK 104 performs processing relating to a servo-on operation. Since it is determined that only the SvCtl TASK 104 controls the spindle motor 12, the SvCtl TASK 104, in step S24, controls the spindle motor 12. That is, in this case, the SvCtl TASK 114 does not control the spindle motor 12 (this control is not contained in the processing relating to a servo-on operation performed in step S42).

In step S43, the SvCtl TASK 114 that does not control the spindle motor 12 sends, to the SvCtl TASK 104, information indicating that the processing relating to a servo-on operation is completed. In step S25, the SvCtl TASK 104 receives that information. Similarly, when, in step S26, the SvCtl TASK 104 sends, to the SvCtl TASK 104, information indicating that the processing relating to a servo-on operation is completed, the information is received by the SvCtl TASK 114 in step S44.

In this way, when the SvCtl TASK 104 and the SvCtl TASK 114 complete the processing relating to a servo-on operation and, thereafter, the information as to the completion is sent, the SvCtl TASK 104, in step S27, completes the servo-on operation. In addition, the SvCtl TASK 114, in step S45, completes the servo-on operation.

As described above, communication is performed between the SvCtl TASK 104 and the SvCtl TASK 114. Thus, the servo-on operation is performed. In addition, through such communication, cooperation between the SvCtl TASK 104 and the SvCtl TASK 114 is realized.

In the servo-on operation illustrated in FIG. 7, a servo-on request is received by the SvCtl TASK 104. However, a similar operation is performed when a servo-on request is received by the SvCtl TASK 114. That is, when a servo-on request is received by the SvCtl TASK 114, the SvCtl TASK 114 performs the processing as shown in steps S21 to S27, and the SvCtl TASK 104 performs processing as shown in steps S41 to S45. Note that the processing relating to control of the spindle motor 12 performed in step S24 is executed by the SvCtl TASK 104.

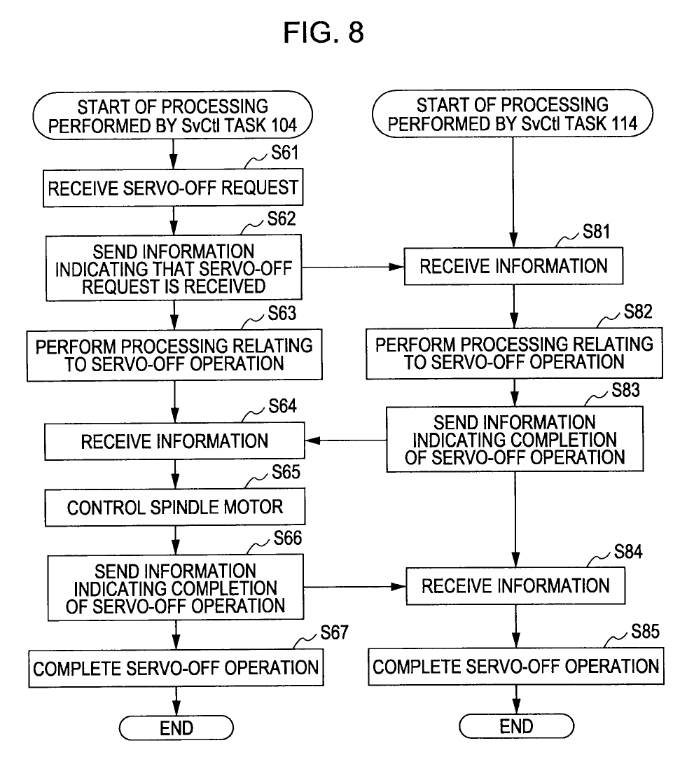

The operations when the servo is turned off are described next with reference to a flowchart shown in FIG. 8. Since the servo-off operation is similar to the servo-on operation, the servo-off operation is described briefly. Like the request to turn on the servo, a request to turn off the servo is sent from the host CPU 16 to the SvCtl TASK 104, and the request is not sent to the SvCtl TASK 114.

In step S61, the SvCtl TASK 104 receives the servo-off request. In step S62, the SvCtl TASK 104 sends information as to the reception of the servo turn-off request to the SvCtl TASK 114. When, in step S81, the SvCtl TASK 114 receives the sent information, the processing proceeds to step S82, where the SvCtl TASK 114 performs processing relating to a servo-off operation. Similarly, in step S63, the SvCtl TASK 104 performs processing relating to a servo-off operation.

In step S83, the SvCtl TASK 114 sends, to the SvCtl TASK 104, information indicating that the processing relating to a servo-off operation is completed. In step S64, the SvCtl TASK 104 receives that information. Upon receiving the information indicating that the processing relating to a servo-off operation is completed, the processing proceeds to step S65, where the SvCtl TASK 104 controls the spindle motor 12. In this case, the SvCtl TASK 104 performs control so as to reduce the rotation speed of the spindle motor 12 and stop the rotation of the spindle motor 12.

As described above, in order to prevent the rotation of the spindle motor 12 from stopping before the SvCtl TASK 114 completes the servo-off operation, the SvCtl TASK 104 stops the rotation of the spindle motor 12 after receiving information from the SvCtl TASK 114. In this way, the rotation of the spindle motor 12 does not stop before the SvCtl TASK 114 completes the servo-off operation. When the rotation of the spindle motor 12 stops, the SvCtl TASK 104, in step S66, sends, to the SvCtl TASK 114, information indicating that the processing relating to a servo-off operation is completed. In step S84, the information is received by the SvCtl TASK 114.

In this way, when the SvCtl TASK 104 and the SvCtl TASK 114 complete the processing relating to a servo-off operation and, thereafter, the information as to the completion is sent, the SvCtl TASK 104, in step S67, completes the servo-off operation. In addition, the SvCtl TASK 114, in step S85, completes the servo-off operation.

As described above, communication is performed between the SvCtl TASK 104 and the SvCtl TASK 114. Thus, the servo-off operation is performed. In addition, through such communication, cooperation between the SvCtl TASK 104 and the SvCtl TASK 114 is realized.

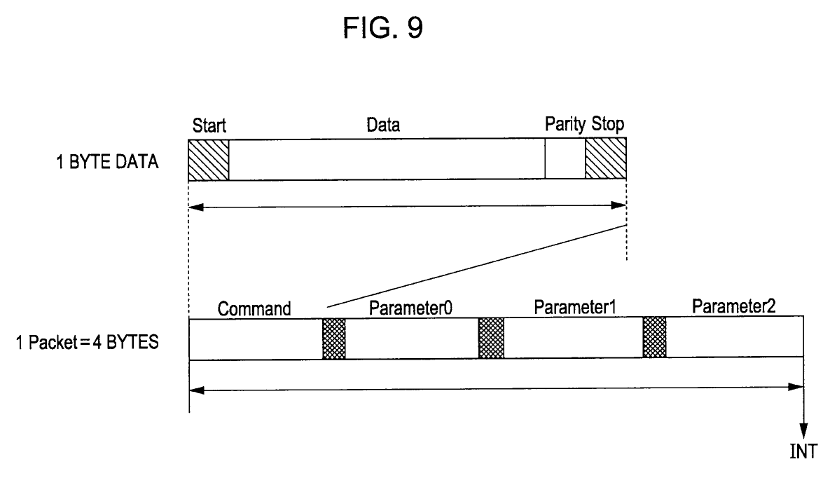

A packet used when the SvCtl TASK 104 and the SvCtl TASK 114 communicate with each other is described next with reference to FIG. 9. Data is communicated on a packet-by-packet basis. A packet is four bytes. One of the four byte includes a start bit (Start), data bits (Data), a parity bit (Parity), and a stop bit (Stop).

The packet includes a 1-byte command (Command), a 1-byte parameter (Parameter 0), a 1-byte parameter (Parameter 1), and a 1-byte parameter (Parameter 2). The packet having such a structure is exchanged between the pickup control unit 35-1 and the pickup control unit 35-2 using, for example, a UART communication method.

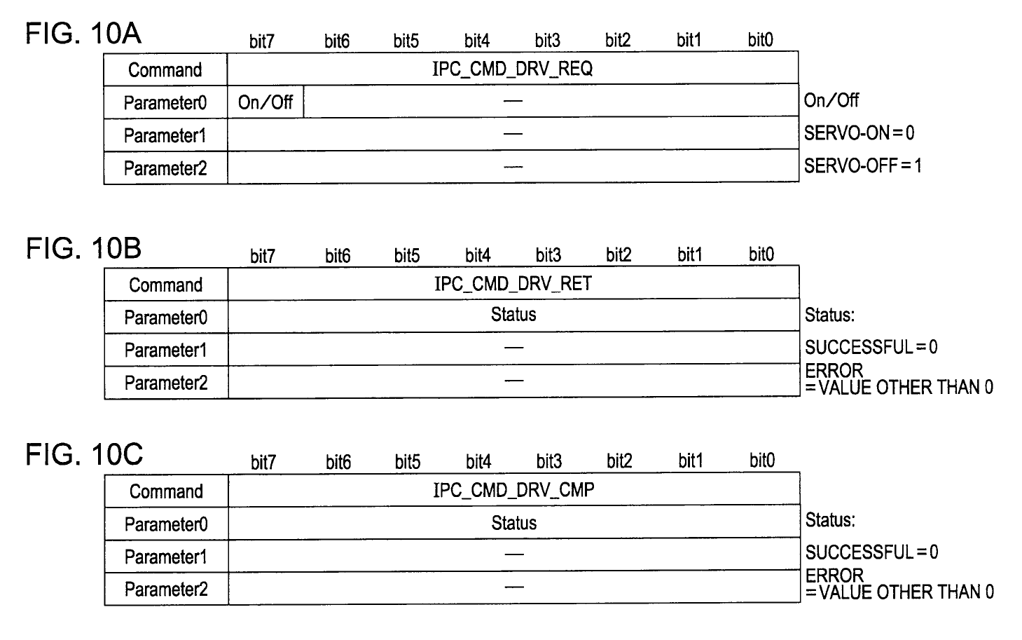

A more detailed structure of the packet is shown in FIGS. 10A to 10C. FIG. 10A illustrates a packet exchanged when a servo-on or servo-off operation is requested. That is, this packet is related to the information sent in step S22 shown in FIG. 7 or the information sent in step S62 shown in FIG. 8.

The command portion (Command) contains the command “IPC_CMD_DRV_REQ” indicating a packet for requesting a servo-on or servo-off operation. A bit 7 of the parameter (Parameter 0) is set to “0” when a servo-on operation is requested, and is set to “1” when a servo-off operation is requested. The other bits are padded with “0” or “1”.

FIG. 10B illustrates a response packet returned when a servo-on or servo-off operation is requested. That is, this packet is a packet related to the information sent in step S43 shown in FIG. 7 or the information sent in step S83 shown in FIG. 8.

The command portion (Command) contains the command “IPC_CMD_DRV_RET” indicating a packet returned in response to a request of a servo-on or servo-off operation. The parameter (Parameter 0) is set to “0” when a servo-on or servo-off operation is successfully completed, and is set to an error code other than “0” when an error occurs in the servo-on or servo-off operation. The error code is used for identifying the type of error. The other bits are padded with “0” or “1”.

FIG. 10C illustrates a packet sent when a servo-on or servo-off operation is completed. That is, this packet is a packet related to the information sent in step S26 shown in FIG. 7 or the information sent in step S66 shown in FIG. 8.

The command portion (Command) contains the command “IPC_CMD_DRV_CMP” indicating that a servo-on or servo-off operation is completed. The parameter (Parameter 0) is set to “0” when a servo-on or servo-off operation is successfully completed, and is set to an error code other than “0” when an error occurs in the servo-on or servo-off operation. The error code is used for identifying the type of error. The other bits are padded with “0” or “1”.

Such packets are exchanged between the pickup control unit 35-1 and the pickup control unit 35-2 when processing relating to the servo-on or servo-off operation is performed.

Other processing performed by the pickup control unit 35-1 and the pickup control unit 35-2 is described next. In the constant linear velocity (CLV) operation, when one of the optical pickup 34-1 and the optical pickup 34-2 starts a seek operation, it is necessary that the rotation speed (SP Target) of the spindle motor 12 is changed in response to the seek operation. At that time, unless the other optical pickup 34 starts a seek operation, the optical pickup 34 does not read the address information on the disk 11. Therefore, it is difficult to perform an operation such as a recording operation or a reproducing operation.

When a seek operation is started in response to a request submitted from one of the optical pickups 34, a seek operation performed in synchronization with the seek operation is referred to as “synchronous seek”. As described below, when data is recorded or reproduced, the data readout position or the data writing position of the optical pickup 34 on the disk 11 may be changed. Accordingly, a seek operation may be necessary. Such a seek operation is referred to as “follow seek”

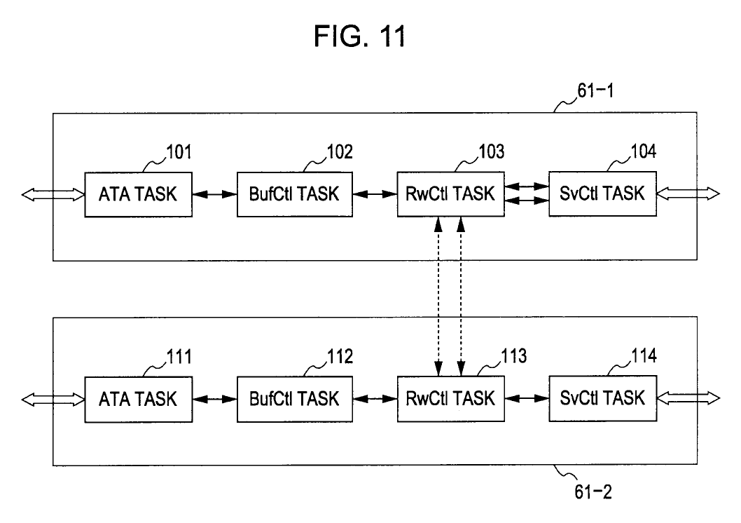

As shown in FIG. 11, when synchronous seek is performed, communication related to the synchronous seek is performed between the RwCtl TASK 103 and the RwCtl TASK 113. An instruction of the synchronous seek is supplied from the host CPU 16 to the LSI 61-1. Thereafter, various commands are exchanged among the ATA TASK 101, the BufCtl TASK 102, the RwCtl TASK 103, and the SvCtl TASK 104 in the LSI 61-1. Alternatively, an instruction of the synchronous seek is supplied from the host CPU 16 to the LSI 61-2. Thereafter, various commands are exchanged among the ATA TASK 111, the BufCtl TASK 112, the RwCtl TASK 113, and the SvCtl TASK 114 in the LSI 61-2.

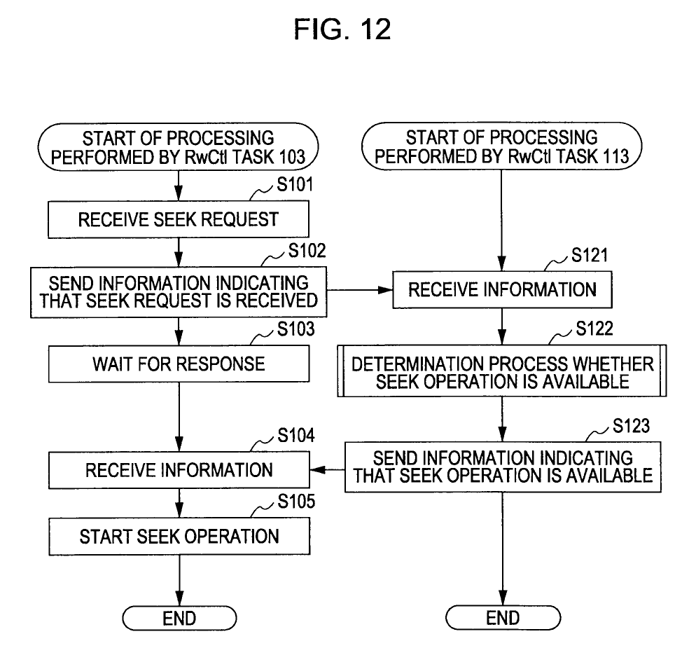

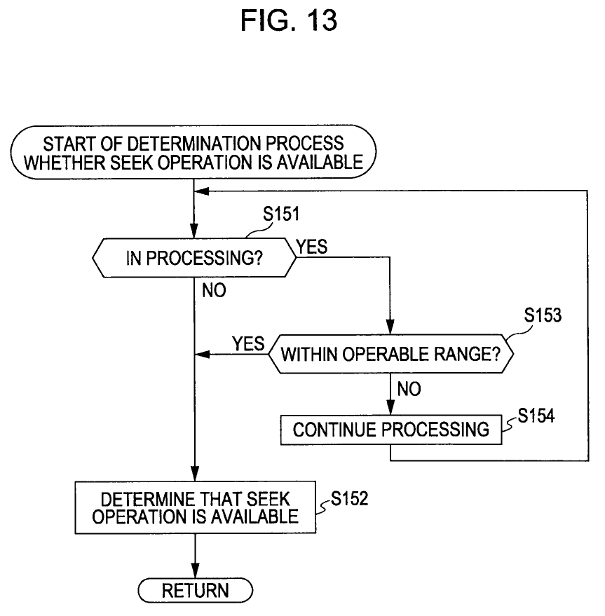

The synchronous seek is described below with reference to a flowchart shown in FIGS. 12 and 13. In the following description, the optical pickup 34-1 submits a request for a seek operation. However, even when the optical pickup 34-2 submits a request for a seek operation, processing similar to processing performed by the optical pickup 34-1 is performed. Therefore, the description of the processing performed by the optical pickup 34-2 is not repeated.

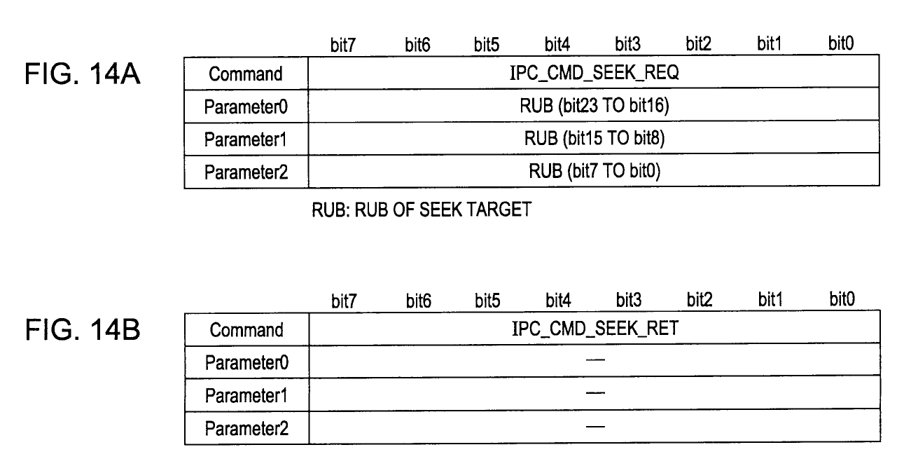

In step S101, the RwCtl TASK 103 receives a seek request. In step S102, the RwCtl TASK 103 controls the serial communication control unit 77 so that information indicating reception of the seek request is sent to the RwCtl TASK 113. At that time, a packet as shown in FIG. 14A is generated and output. Like the above-described packets, the packet shown in FIG. 14A is four bytes.

The command portion (Command) contains the command “IPC_CMD_SEEK_REQ” indicating reception of a seek request. The parameter (Parameter 0) contains a recording unit block (RUB) (bits 23 to 16). The parameter (Parameter 1) contains the RUB (bits 15 to 8). The parameter (Parameter 2) contains the RUB (bits 7 to 0).

The parameter 0, parameter 1, and parameter 2 together include the address of a seek target point. In this way, when sending information indicating reception of the seek request, the RwCtl TASK 103 also sends data indicating which address is sought.

When a packet as shown in FIG. 14A is sent in step S102, the packet is received by the RwCtl TASK 113 in step S121. In step S112, the RwCtl TASK 113 determines whether the seek operation is available. This determination of availability of the seek operation is described in more detail below with reference to FIG. 13. In step S112, the determination of availability of the seek operation is made. If, in step S112, it is determined that the seek operation is available, the processing proceeds to step S123.

In step S123, the RwCtl TASK 113 sends, to the RwCtl TASK 103, information indicating that a seek operation is available. A packet used for sending the information is shown in FIG. 14B. The command portion (Command) contains the command “IPC_CMD_SEEK_RET” indicating a packet returned in response to a seek request. That is, a command indicating that a seek operation is available is contained in the command portion. The other portion is padded with “0” or “1”.

In step S104, the RwCtl TASK 103 receives the information sent from the RwCtl TASK 113. In step S103, the RwCtl TASK 103 maintains a response waiting state from when it sends information indicating that a seek operation is received in step S102 to when it receives, from the RwCtl TASK 113, information indicating that a seek operation is available in step S104. In step S105, the RwCtl TASK 103 starts a seek operation.

As described above, when one of the optical pickup 34-1 and the optical pickup 34-2 receives a seek request, a seek operation is not started until the other optical pickup permits the seek operation.

The determination process whether a seek operation is available performed in step S122 is described with reference to the flowchart shown FIG. 13.

In step S151, the RwCtl TASK 113 determines whether some processing is being performed. That is, upon receiving information indicating that a seek request is received, the RwCtl TASK 113 determines whether processing, such as data writing or data readout, is being performed. If, in step S151, it is determined that any process is not being performed, the processing proceeds to step S152. In step S152, it is determined that a seek operation is available in response to the seek request. If such determination is made, permission to perform the seek operation is sent to the RwCtl TASK 103 that has sent the seek request.

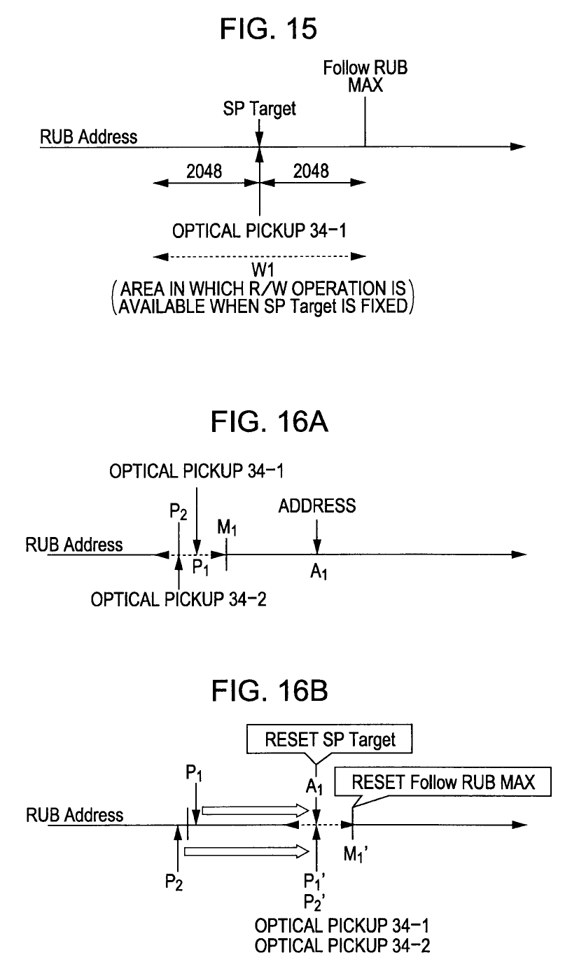

However, if, in step S151, it is determined that some process is being performed, the processing proceeds to step S153. In step S153, it is determined whether the optical pickup 34-1 and the optical pickup 34-2 are located within an operable range. This determination is described below with reference to FIG. 15. In FIG. 15, the term “SP Target” represents a physical address serving as a reference address used for determining the rotation speed of the spindle motor 12. This physical address is represented using a RUB address. The RUB address is a physical address on the disk 11.

Assume that the optical pickup 34-1 is located at the SP Target. The range of the RUB address from and to which the optical pickup 34-1 and the optical pickup 34-2 can successfully perform a readout operation and a recording/reproducing operation is a range w1 that is within 2048 RUB Addresses from the SP Target in the forward and backward directions.

That is, if the optical pickup 34-2 is located at a position within −2048 RUB Addresses from the position where the optical pickup 34-1 is located, the optical pickup 34-1 and the optical pickup 34-2 can successfully operate. In addition, if the optical pickup 34-2 is located at a position within +2048 RUB Addresses from the position where the optical pickup 34-1 is located, the optical pickup 34-1 and the optical pickup 34-2 can successfully operate.

As described above, if one of the optical pickups 34 is located within ±2048 RUB Addresses from a location at which the other optical pickup 34 is located, the optical pickup 34-1 and the optical pickup 34-2 can successfully perform readout of the physical address and recording/reconstruction operation even when an error of a linear velocity (CLV: constant linear velocity) occurs between the optical pickup 34-1 and the optical pickup 34-2.

Accordingly, in step S153, it is determined whether the optical pickup 34-2 is located within ±2048 RUB Addresses from an address to be sought that the optical pickup 34-1 requests (i.e., a target address). If the optical pickup 34-2 is located within ±2048 RUB Addresses from the target address, it is determined that the optical pickup 34-1 and the optical pickup 34-2 are located within an operable range. Thereafter, the processing proceeds to step S152, where information indicating that a seek operation is available is sent.

More specifically, in step S153, the determination whether the optical pickup 34-1 and the optical pickup 34-2 are located within an operable range is made by determining whether the following condition is satisfied:

|(target RUB address)−(currently processed RUB address)|<2048.

That is, it is determined whether the absolute value of a value obtained by subtracting the address at which the optical pickup 34-2 is located from the target address is less than 2048. If it is determined that the absolute value is less than 2048, the processing proceeds to step S152, where information indicating that a seek operation is available is sent.

However, if, in step S153, it is determined that the optical pickup 34-1 and the optical pickup 34-2 are not located within an operable range, the processing proceeds to step S154, where the optical pickup 34-2 continues the operation currently performed. For example, if, at that time, the optical pickup 34-2 is reading data, the optical pickup 34-2 continues the data readout operation.

The seek operation illustrated by the flowcharts shown in FIGS. 12 and 13 is described in more detail below with reference to FIGS. 16A and 16B. Assume that a seek request is sent to the optical pickup 34-1 when the optical pickup 34-1 and the optical pickup 34-2 are located at the positions shown in FIG. 16A. In FIG. 16A, the optical pickup 34-1 is located at a position P1, and the optical pickup 34-2 is located at a position P2. In addition, the position P1 and the position P2 are located in an operable range. At that time, a maximum physical address within the operable range is M1. The maximum value M1 is referred to as a “Follow RUB MAX”. When the position P1 or P2 becomes the Follow RUB MAX, the SP Target should be reset.

Assume that an address A1 is specified as a target address when the optical pickup 34-1 and the optical pickup 34-2 are located at the positions shown in FIG. 16A. In addition, the address A1 is greater than the maximum value M1 of the operable range. Then, if only the optical pickup 34-1 seeks the position defined by the address A1, the optical pickup 34-2 is located outside the operable range. In such a case, the operation currently performed by the optical pickup 34-2 (e.g., a write operation) fails. Accordingly, a seek operation is not performed until the optical pickup 34-2 completes its operation (see step S154).

After the optical pickup 34-2 completes its operation, a seek operation is allowed. Thus, a seek operation is performed. That is, in this case, the optical pickup 34-1 and the optical pickup 34-2 are moved to the position defined by the address A1 (i.e., the target address). As shown in FIG. 16B, the optical pickup 34-1 is moved from the position P1 to a position P1′ defined by the address A1. The optical pickup 34-2 is moved from the position P2 to a position P2′ defined by the address A1.

At that time, the SP Target is set to the address A1. The rotation of the spindle motor 12 is controlled so as to provide the rotation speed in accordance with the address A1. In addition, since the SP target is reset, the Follow RUB MAX is also reset to a maximum value M1′.

In this way, when a seek request is received, it is determined whether the optical pickup 34-1 and the optical pickup 34-2 are located within the operable range. In order to realize such a seek operation, an inquiry asking whether the seek operation is available and a response indicating that the seek operation is available are exchanged between the pickup control unit 35-1 and the pickup control unit 35-2. By performing such communication, the two optical pickups 34 can cooperate.

When a seek request is received, a seek operation is performed in the above-described manner. However, a seek operation may be necessary even when no seek request is received. For example, when data is read out, the readout position is sequentially changed. Accordingly, a seek operation is necessary in accordance with the change in the readout position.

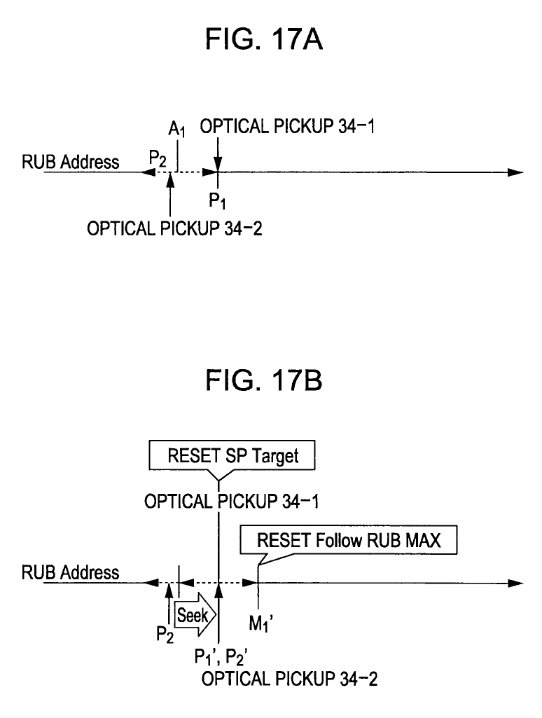

This seek operation is described with reference to FIGS. 17A and 17B. As shown in FIG. 17A, while the optical pickup 34-1 is reading data, the optical pickup 34-1 moves to a position P1. When the optical pickup 34-1 moves to the position defined by the maximum value M1 (Follow RUB MAX), it is difficult to continue the readout operation using the rotation speed for the SP target. Accordingly, it is necessary that the SP target be reset. In such a case, for example, the SP target is reset to a position defined by the maximum value M1 (the value of the Follow RUB MAX at that time) (see FIG. 17B).

Since the position of the optical pickup 34-1 is set as a new SP Target, it is necessary that the optical pickup 34-2 starts a seek operation. In this case, the optical pickup 34-2 sets the target address to the position defined by the new SP Target and performs a seek operation. While the seek operation is performed, the value of the Follow RUB Max is reset to a maximum value M1′.

As a recording operation and a reproducing operation are continuously performed in a CLV operation mode, the difference between the SP Target and the position of the optical pickup 34 (the optical head 33) exceeds a predetermined value. Accordingly, it is necessary that the SP Target be reset. At that time, in accordance with the position of one of the optical pickups 34, the other optical pickup 34 is necessary to seek a position within the SP Target ±2048. Such seeking is referred to as “Follow seek”.

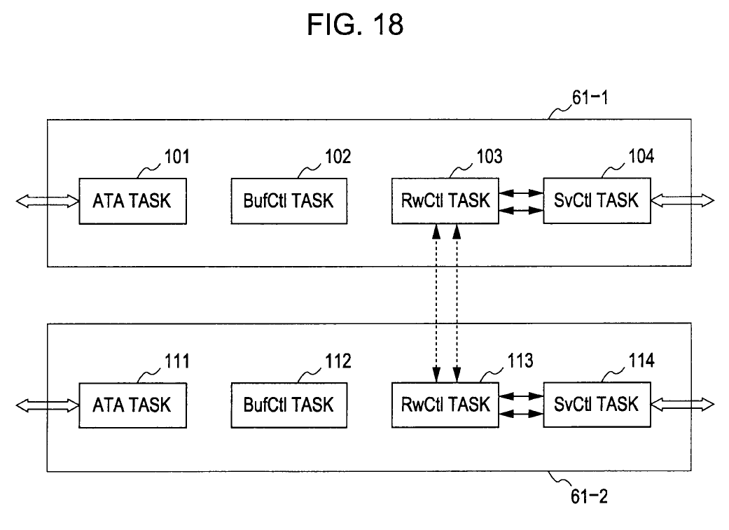

The Follow seek is described in more detail below. Follow seek is performed when data is written to the disk 11 or data is read from the disk 11. Accordingly, as shown in FIG. 18, communication relating to the Follow seek is performed between the RwCtl TASK 103 and the RwCtl TASK 113. In addition, the Follow seek is performed while the RwCtl TASK 103 and the RwCtl TASK 113 are controlling a recording and reproducing operation. That is, the Follow seek is not performed in response to a request from the other tasks. Accordingly, the Follow seek is performed through only communication between the RwCtl TASK 103 and the RwCtl TASK 113 and communication with the SvCtl TASK 104 and the SvCtl TASK 114 are performed.

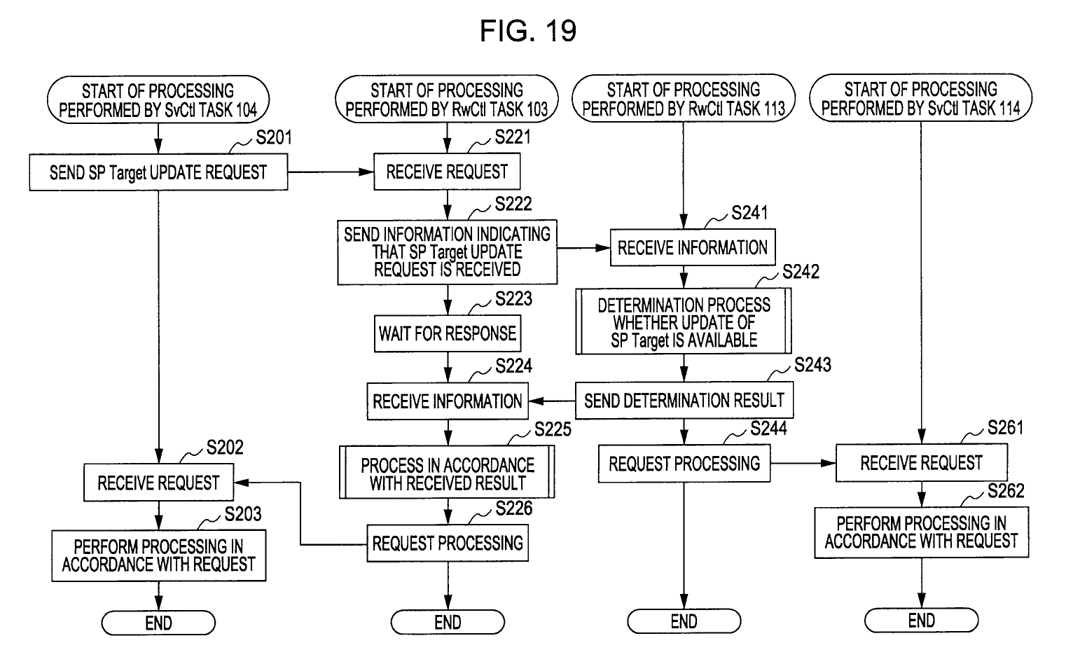

The Follow seek is described with reference to a flowchart shown in FIGS. 19 to 21.

In step S201, the SvCtl TASK 104 requests the RwCtl TASK 103 to update the SP Target. As noted above, when the SvCtl TASK 104 controls data recording and reproducing operation and if the difference between the SP Target and the position of the optical pickup 34 exceeds a predetermined value, it is necessary that the SP target be reset. At that time, the SvCtl TASK 104 requests the RwCtl TASK 103 to update the SP target.

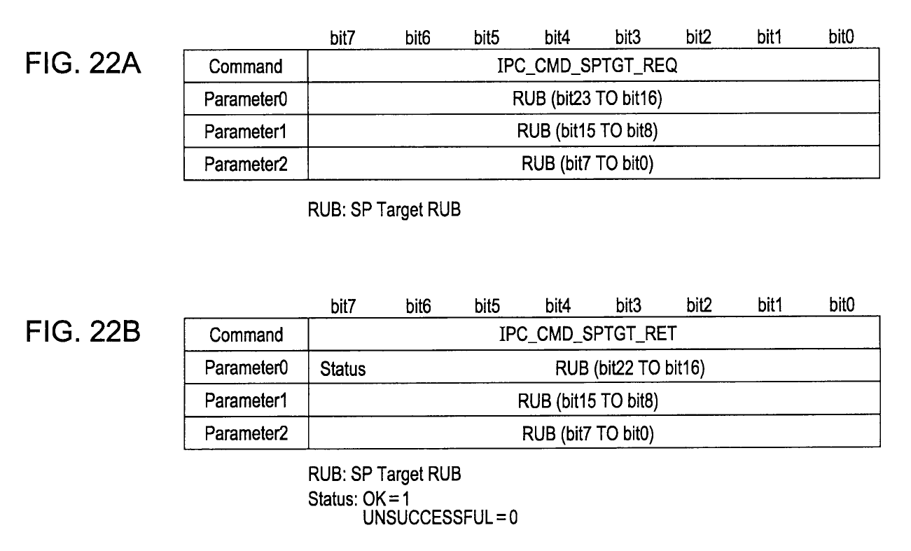

In step S221, the RwCtl TASK 103 receives an SP Target update request. In step S222, the RwCtl TASK 103 controls the serial communication control unit 77 so as to send, to the RwCtl TASK 113, information indicating that update of the SP Target is requested. At that time, a packet as shown in FIG. 22A is generated and output. Like the above-described packets, the packet as shown in FIG. 22A is four bytes.

The command portion (Command) contains the command “IPC_CMD_SPTGT_REQ” indicating that update of the SP Target is requested. The parameter (Parameter 0) contains a RUB (bits 23 to 16). The parameter (Parameter 1) contains the RUB (bits 15 to 8). The parameter (Parameter 2) contains the RUB (bits 7 to 0).

The Parameter 0, Parameter 1, and Parameter 2 together contain the target address of the SP Target. As described above, upon sending information that a request to update the SP Target is received, the RwCtl TASK 103 also sends information indicating which address is the SP Target.

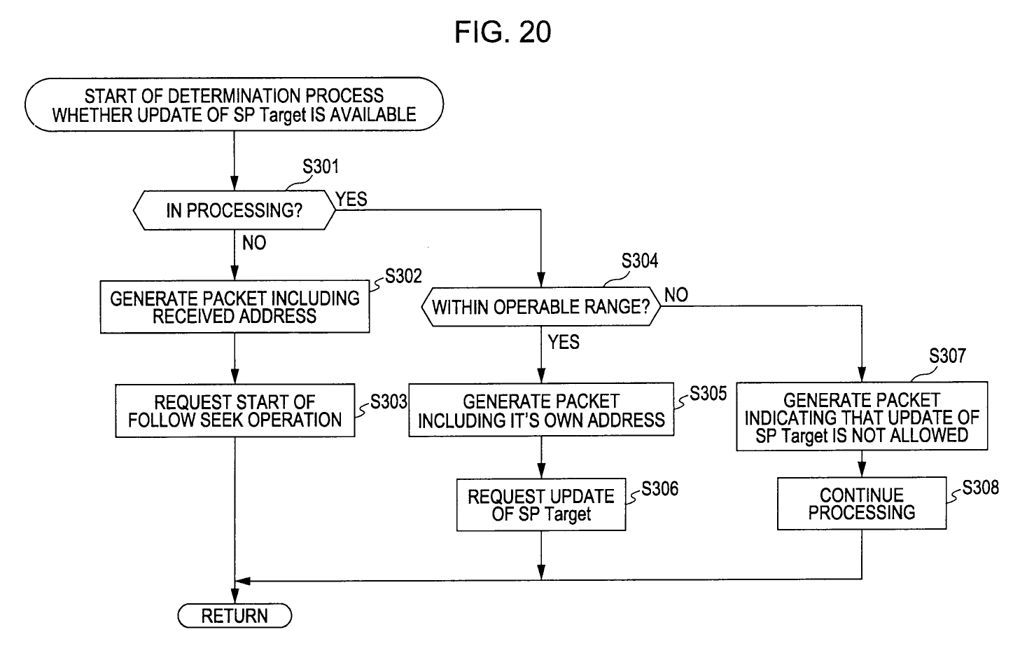

When the packet as shown in FIG. 22A is sent in step S222, the RwCtl TASK 113, in step S241, receives the packet. In step S242, the RwCtl TASK 113 determines whether the SP target can be updated. The determination whether the SP target can be updated made in step S242 is described in more detail below with reference to FIG. 20. After the determination whether the SP target can be updated is made in step S242, the processing proceeds to step S243.

In step S243, the RwCtl TASK 113 sends, to the RwCtl TASK 103, the determination result as to whether a seek operation is available. A packet used for sending the determination result is shown in FIG. 22B. The command portion (Command) contains the command “IPC_CMD_SPTGT_RET” indicating a packet returned in response to a request of updating the SP Target. A bit 7 of the parameter (Parameter 0) contains a value indicating a status as to whether update of the SP Target is allowed or not. The bits of the parameter (Parameter 0) other than bit 7 contain a RUB (bits 22 to 16). A parameter (Parameter 1) contains the RUB (bits 15 to 8). A parameter (Parameter 2) contains the RUB (bits 7 to 0).

In step S224, the RwCtl TASK 103 receives such information sent from the RwCtl TASK 113. In step S223, the RwCtl TASK 103 maintains a response waiting state from when it sends information indicating that the SP Target update request is received in step S222 to when it receives, from the RwCtl TASK 113, information indicating whether update of the SP Target is available in step S224. In step S225, the RwCtl TASK 103 starts processing in accordance with the received result. The processing performed in step S225 in accordance with the received result is described in more detail below with reference to FIG. 22.

After the processing performed in step S225 in accordance with the received result is completed, processing to be performed by the SvCtl TASK 104 is determined. In order to perform the determined processing, a request is sent to the SvCtl TASK 104 in step S226. In this example, while the RwCtl TASK 103 determines the processing to be performed and sends a request to the SvCtl TASK 104, the received information may be sent from the RwCtl TASK 103 to the SvCtl TASK 104, and the SvCtl TASK 104 may determine the processing to be performed.

In step S202, upon receiving the request from the RwCtl TASK 103, the SvCtl TASK 104, in step S203, performs the processing in accordance with the request. As described below, the processing is related to the setting of the SP Target.

In addition, upon sending the determination result to the RwCtl TASK 103 in step S243, the RwCtl TASK 113, in step S244, sends, to the SvCtl TASK 114, a request to execute processing in accordance with the determination result. Upon receiving the request sent from the RwCtl TASK 113 in step S261, the SvCtl TASK 114, in step S262, executes processing in accordance with the request. As described below, the processing is related to the setting of the SP Target.

In this way, the optical pickup 34-1 and the optical pickup 34-2 (the pickup control unit 35-1 and the pickup control unit 35-2 that control the optical pickup 34-1 and the optical pickup 34-2, respectively) communicate with each other. Each of the optical pickup 34-1 and the optical pickup 34-2 examines the state of the other optical pickup 34 and performs an appropriate processing relating to the SP Target, that is, the follow seek operation in this example.

The determination process as to whether update of the SP target is available performed in step S242 is described with reference to the flowchart shown in FIG. 20.

In step S301, the RwCtl TASK 113 determines whether it is in a processing mode. That is, upon receiving the information indicating that an SP Target update request is received, the RwCtl TASK 113 determines whether it is performing a data write operation or a data read operation. If, in step S301, it is determined that the RwCtl TASK 113 is not in a processing mode, the processing proceeds to step S302, where a packet including the address contained in the received packet is generated.

Step S302 is performed when the RwCtl TASK 113 determined that it is not in a processing mode, that is, when the optical pickup 34-2 is not executing a data write operation or a data read operation and is in an idle mode. In such a case, the optical pickup 34-2 can be moved to any location. Thus, the optical pickup 34-2 is moved in response to the request from the optical pickup 34-1.

Accordingly, in this case, a response indicating that the SP Target can be updated to the SP Target address requested by the RwCtl TASK 103 is sent to the RwCtl TASK 103. This response has a packet structure as shown in FIG. 22B. The address sent from the RwCtl TASK 103 as an SP Target address is stored in the parameters (Parameter 0, Parameter 1, and Parameter 2) of the packet.

In step S243, the packet generated in this manner is output to the RwCtl TASK 103 as a determination result. In addition to outputting the packet, the RwCtl TASK 113, in step S303, requests the SvCtl TASK 114 to start follow seek. Upon receiving the request, the RwCtl TASK 113, in step S244, sends a processing request to the SvCtl TASK 114.

The request to start follow seek is described next with reference to FIGS. 17A and 17B. As shown in FIG. 17A, while the optical pickup 34-1 is located at a position indicated by the Follow RUM MAX, a request to update the SP Target is issued. In this case, when processing is performed in step S303, an instruction to move the optical pickup 34-2 to the position at which the optical pickup 34-1 is located is sent to the SvCtl TASK 114.

That is, a seek operation is performed so that the optical pickup 34-2 seeks a position indicated by the RUB Address of the reset SP Target. Accordingly, in step S303, a request to seek while following the optical pickup 34-1 is sent. By sending such a seek operation to the SvCtl TASK 114, the SvCtl TASK 114 starts follow seek. In this way, the follow seek is performed.

However, if, in step S301, it is determined that the RwCtl TASK 113 is in a processing mode, the processing proceeds to step S304. In step S304, it is determined whether the optical pickup 34-1 and the optical pickup 34-2 are located in an operable range. Since the determination whether the optical pickup 34-1 and the optical pickup 34-2 are located in the operable range has already been illustrated in FIG. 15, the description is not repeated. If, in step S304, it is determined that the optical pickup 34-1 and the optical pickup 34-2 are located in an operable range, the processing proceeds to step S305.

In step S305, a packet including the address of its own is generated. The processing in step S305 is performed when, under the control of the RwCtl TASK 113, the optical pickup 34-2 is performing a data write operation or a data read operation and if the reset SP Target and the optical pickup 34-2 are located in the operable range. In such a case, the SP Target can be updated. However, the range of the SP Target is limited. Accordingly, as described in more detail below, the RwCtl TASK 103 determines whether the location of the optical pickup 34-1 is determined as a new SP Target or the location of the optical pickup 34-2 is determined as a new SP Target. Thus, the generated packet to be sent to the RwCtl TASK 103 includes the address at which the optical pickup 34-2 is located (the address of its own).

In step S243, the packet generated in this manner is output to the RwCtl TASK 103 as a determination result. The packet is sent from the RwCtl TASK 113 to the RwCtl TASK 103. In addition, in step S306, the RwCtl TASK 113 sends an SP Target update request to the SvCtl TASK 114. Upon receiving the request, the RwCtl TASK 113, in step S244, sends a processing request to the SvCtl TASK 114. The SP Target is set to the RUB Address of one of the optical pickup 34-1 and the optical pickup 34-2 which is located on the inner periphery side.

The SvCtl TASK 114 compares the RUB Address of the optical pickup 34-2 that is controlled by the SvCtl TASK 114 with the target address of the SP Target contained in the information sent from the RwCtl TASK 103 (the RUB Address at which the optical pickup 34-1 is located). Thereafter, the SvCtl TASK 114 set the address on the peripheral side for the SP Target.

Such process is performed by the SvCtl TASK 114 on the basis of the request sent from the RwCtl TASK 113.

However, if, in step S304, it is determined that the optical pickup 34-1 and the optical pickup 34-2 are located in an operable range, the processing proceeds to step S307, where a packet indicating that update of the SP Target is not allowed is generated. In step S243, the packet generated in this manner is output to the RwCtl TASK 103 as a determination result. In step S308, the optical pickup 34-2 continues the processing performed at that time. For example, if the optical pickup 34-2 reads data at that time, the data read operation is continued.

In this example, the processes indicated by the flowchart shown in FIG. 20 are performed by the RwCtl TASK 113. However, all or some of the processes may be performed by the SvCtl TASK 114. For example, the information in the packet received by the RwCtl TASK 113 may be supplied to the SvCtl TASK 114. Thereafter, the SvCtl TASK 114 may analyze the information of the packet and determine the address of the SP Target (i.e., the processes in steps S303 and S306 may be performed). Alternatively, the determined address information may be supplied from the SvCtl TASK 114 to the RwCtl TASK 113. Thereafter, the RwCtl TASK 113 may generate a packet on the basis of the supplied address (i.e., the processes in steps S302, S305 and S307 may be performed).

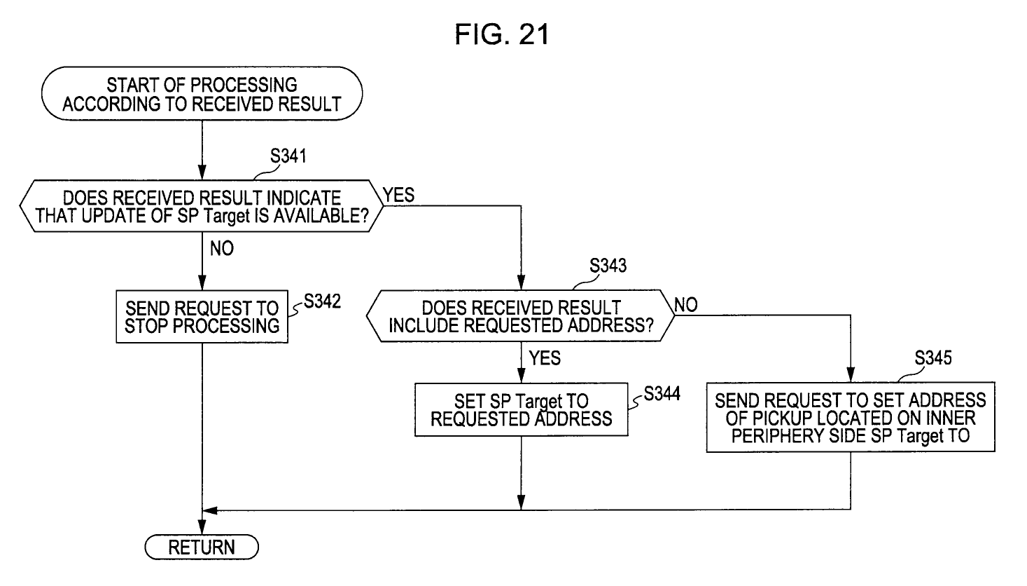

Such processing is performed by the tasks that are requested to update the SP Target (the RwCtl TASK 113 and the SvCtl TASK 114 that control the optical pickup 34-2 in this example), while processing in accordance with the reception result is performed in step S225 (see FIG. 19) by the tasks that request update of the SP Target (the RwCtl TASK 103 and the SvCtl TASK 104 that control the optical pickup 34-1). The processing performed in step S225 in accordance with the reception result is described with reference to the flowchart shown FIG. 21.

In step S341, the RwCtl TASK 103 analyzes the information sent from the RwCtl TASK 113 and determines whether the information indicates that update of the SP Target is permitted. This determination is made by referring to the information contained in bit 7 of the parameter (Parameter 0) of the received packet (see FIG. 22B). That is, if 11111 is contained, it is determined that update of the SP Target is permitted. However, if “0” is contained, it is determined that update of the SP Target is not permitted.

If, in step S341, it is determined that update of the SP Target is not permitted, the processing proceeds to step S342, where a request to stop the processing is issued to the SvCtl TASK 104. In step S226, upon receiving the request, a request to stop the processing is issued from the RwCtl TASK 103 to the SvCtl TASK 104. Upon receiving the request, the SvCtl TASK 104 stops the current processing, such as data write processing or data read processing. That is, the SvCtl TASK 104 enters a waiting mode until the optical pickup 34-2 enters a mode in which update of the SP Target can be permitted.

However, if, in step S341, it is determined that update of the SP Target is permitted, the processing proceeds to step S343, where it is determined whether a requested address is contained or not. As used herein, the term “requested address” refers to the address that the RwCtl TASK 103, in step S222, sets in the packet indicating that a request to update the SP Target is received. If, in step S343, it is determined that the address contained in the received packet is the requested address, the processing proceeds to step S344.

In step S344, a request to set the requested address (the address at which the optical pickup 34-1 is located at that time and, more particularly, the position indicated by the Follow RUB Address) as a new SP Target is issued to the SvCtl TASK 104. Upon receiving such a request issued to the SvCtl TASK 104, the SvCtl TASK 104 sets a new SP Target so that the rotation of the spindle motor 12 is controlled on the basis of the set SP Target.

However, if, in step S343, it is determined that the address contained in the received packet is not the requested address, the processing proceeds to step S345. In such a case, the address contained in the received packet is the address contained in the packet generated by the RwCtl TASK 113 in step S305 (see FIG. 20). That is, the address is the RUB Address at which the optical pickup 34-2 is located.

The RwCtl TASK 103 compares the address at which the optical pickup 34-1 is located with the address at which the optical pickup 34-2 is located. The RwCtl TASK 103 then issues, to the SvCtl TASK 104, a request to set the address of the optical pickup 34 located on the inner periphery side as a new SP Target. When receiving such a request issued to the SvCtl TASK 104, the SvCtl TASK 104 sets a new SP Target so that the rotation of the spindle motor 12 is controlled on the basis of the set SP Target.

Note that processing similar to the processing performed in step S345 may be performed in step S344. That is, in step S345, the RwCtl TASK 103 compares the address at which the optical pickup 34-1 is located with the received address at which the optical pickup 34-2 is located and issues, to the SvCtl TASK 104, a request to set the address of the optical pickup 34 located on the inner periphery side as a new SP Target. In this case, the two addresses are the same. As a result, the address at which the optical pickup 34-1 is located is set as a new SP Target.

In addition, in such a case, the processing performed in step S343 can be removed. That is, the process in which the address at which the optical pickup 34-1 is located with the received address at which the optical pickup 34-2 is located and the process in which the address of the optical pickup 34 located on the inner periphery side is set as a new SP Target is performed without using the address contained in the received packet. Accordingly, the determination process performed in step S343 can be removed.

In this example, the processes indicated by the flowchart shown in FIG. 21 are performed by the RwCtl TASK 103. However, all or some of the processes may be performed by the SvCtl TASK 104. For example, the information in the packet received by the RwCtl TASK 103 may be supplied to the SvCtl TASK 104. Thereafter, the SvCtl TASK 104 may analyze the information of the packet and determine the address of the SP Target (i.e., the processes in steps S344 and S345 may be performed).

In this way, one of the optical pickup 34-1 and the optical pickup 34-2 performs communication, and performs appropriate processing (i.e., a follow seek process in this example) while examining the modes of the optical pickup 34-1 and the optical pickup 34-2.

While the above description has been made with reference to the case in which the optical pickup 34-1 issues a seek operation request, a similar operation is performed even when the optical pickup 34-2 issues a seek operation request. Accordingly, the descriptions are not repeated. However, since the SvCtl TASK 104 controls the spindle motor 12, the SvCtl TASK 104 sends, to the spindle motor 12, an instruction to determine the setting of the SP Target. Accordingly, even when the optical pickup 34-2 sends a seek operation request, the SvCtl TASK 114 does not send, to the spindle motor 12, an instruction to determine the setting of the SP Target.

In addition, while the above description has been made with reference to the case in which the optical pickup 34-1 and the optical pickup 34-2 are disposed in the optical head 33 shown in FIG. 2, the above-described processing can be applied to even the case in which, as shown in FIG. 1, the optical head 13-1 and the optical head 13-2 include the optical pickup 14-1 and the optical pickup 14-2, respectively. Thus, the present invention is applicable to that case.

As described above, according to the present embodiment of the present invention, for example, an integrated IC chip set used for drives of personal computers can be used for a drive apparatus including two optical pickups without developing a dedicated device.

In addition, by using such IC chip sets and allowing the IC chip sets to communicate with each other, two optical pickups can be appropriately controlled. Furthermore, the two optical pickups can cooperate.

Still furthermore, by using the chip set, the consumption power can be reduced, and the size of a circuit board can be reduced. As a result, the size of the drive can be reduced, and the manufacturing cost of the drive can be reduced.

The above-described series of processes (e.g., the tasks shown in FIG. 5) can be executed not only by hardware but also by software. When the above-described series of processes are executed by software, the programs of the software are installed from a program recording medium into a computer incorporated in dedicated hardware or a computer that can execute a variety of function by installing a variety of programs therein (e.g., a general-purpose personal computer).

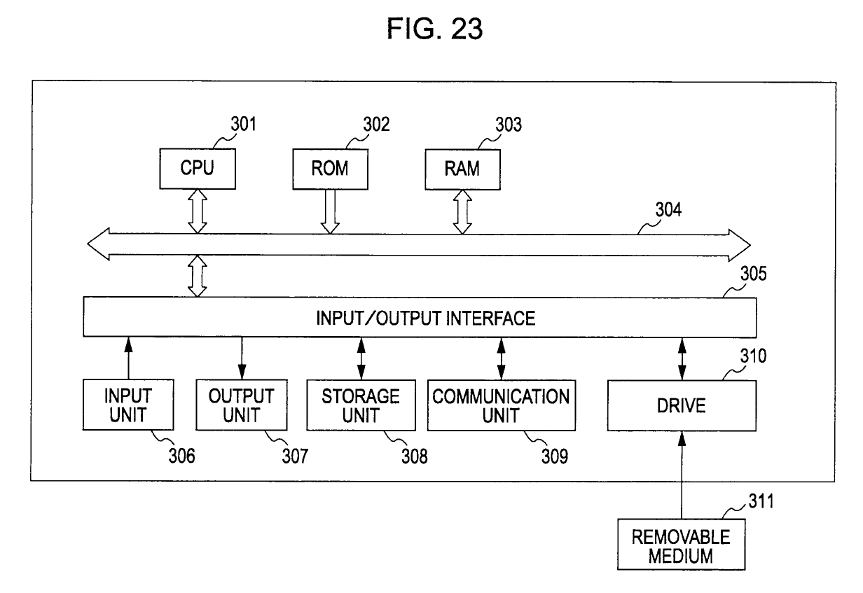

FIG. 23 is a block diagram of an exemplary hardware configuration of a personal computer that executes the above-described series of processes using a program.

In the personal computer, a central processing unit (CPU) 301, a read only memory (ROM) 302, and a random access memory (RAM) 303 are connected to one another via a bus 304.

An input/output interface 305 is further connected to the bus 304. The following units are connected to the input/output interface 305: an input unit 306 including, for example, a keyboard, a mouse, and a microphone, an output unit 307 including, for example, a display and a speaker, a storage unit 308, such as a hard disk or a nonvolatile memory, a communication unit 309 including, for example, a network interface, and a drive 310 that drives a removable medium 311. Examples of the removable medium 311 include a magnetic disk, an optical disk, a magneto-optical disk, and a semiconductor memory.

In the personal computer having such a configuration, the CPU 301 loads a program stored in, for example, the storage unit 308, into the RAM 303 via the input/output interface 305 and the bus 304. Thereafter, the CPU 301 executes the loaded program so that the above-described series of processes can be executed.

The program executed by the personal computer (the CPU 301) is stored in the removable medium 311 which is a package medium composed of a magnetic disk (including a flexible disk), an optical disk (e.g., a compact disc-read only memory (CD-ROM) and a digital versatile disc (DVD)), a magneto-optical disk, or a semiconductor memory. Alternatively, the program is downloaded via a wired or wireless transmission medium, such as a local area network, the Internet, or a digital satellite broadcast. Thus, the program is provided to users.

Thereafter, by mounting the removable medium 311 on the drive 310, the program can be installed in the storage unit 308 via the input/output interface 305. Alternatively, the program can be installed in the storage unit 308 by receiving the program via a wired or wireless transmission medium using the communication unit 309. Still alternatively, the program can be pre-installed in the ROM 302 or the storage unit 308.

The program executed by the personal computer may be a program that sequentially performs the processes described above or a program that executed the above-described processes in parallel or on demand.

In addition, as used herein, the term “system” refers to a combination of a plurality of devices.

The present application contains subject matter related to that disclosed in Japanese Priority Patent Application JP 2008-186096 filed in the Japan Patent Office on Jul. 17, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A drive apparatus comprising:
n optical pickups;
n control means, each controlling a corresponding one of the n optical pickups; and
communication means for allowing the n control means to communicate with one another.

2. The drive apparatus according to claim 1, wherein each of the control means is made from the same type of LSI.

3. The drive apparatus according to claim 1, wherein first control means of the n control means receives an instruction to turn on or off servo control, and wherein, upon receiving the instruction to turn on or off servo control, the first control means sends, to another control means, information indicating the reception of the instruction.

4. The drive apparatus according to claim 1, wherein the n control means are supplied with an FG signal from a spindle motor, and wherein first control means of the n control means controls the spindle motor.

5. The drive apparatus according to claim 1, wherein, upon receiving a seek request, first control means of the n control means sends information indicating the reception of the seek request to second control means different from the first control means, and wherein, upon receiving the information, the second control means determines whether a seek operation is available, and wherein, if the seek operation is available, the second control means sends, to the first control means, information indicating that the seek operation is allowed, and wherein, upon receiving the information indicating that the seek operation is allowed, the first control means starts the seek operation.

6. The drive apparatus according to claim 5, wherein it is determined that the seek operation is available if the second control means performs no processing or a RUB Address of a target seek position is located within a range defined by a RUB address at which the optical pickup controlled by the second control means is located ±2048 RUB Addresses.

7. The drive apparatus according to claim 1, wherein, upon receiving an SP Target update request, first control means of the n control means sends information indicating the reception of the SP Target update request to a second control means different from the first control means, and wherein, upon receiving the information, the second control means determines whether an SP Target update operation is available and sends, to the first control means, information indicating a determination result, and wherein, upon receiving the information indicating the determination result, the first control means starts processing in accordance with the determination result.

8. The drive apparatus according to claim 7, wherein it is determined that the SP Target update operation is available if the second control means performs no processing or a RUB Address of an SP Target update position is located within a range defined by a RUB address at which the optical pickup controlled by the second control means is located ±2048 RUB Addresses.

9. The drive apparatus according to claim 7, wherein, if the determination result received from the second control means indicates that the update of the SP Target is not allowed, the first control means stops processing, and wherein, if the determination result received from the second control means indicates that the update of the SP Target is allowed, the first control means updates the SP Target to the SP Target requested by the first control means, and wherein, when the determination result received from the second control means indicates that the update of the SP Target is allowed and if the determination result includes an address at which the optical pickup controlled by the second control means is located, the first control means updates the SP Target to an address at which, of the two optical pickups controlled by the second control means and the first control means, the optical pickup located on the inner periphery side is located.

10. The drive apparatus according to claim 1, wherein n is 2, and wherein two optical pickups are mounted in one optical head.

11. A method for driving a drive apparatus, the drive apparatus including n optical pickups, n control means, each controlling a corresponding one of the n optical pickups, and communication means for allowing the n control means to communicate with one another, the method comprising the step of:
controlling communication performed by the communication means so that, when a recording or reproducing operation is performed by the n optical pickups, information is exchanged among the n control means, and the n optical pickups are capable of cooperating.

12. A computer-readable program comprising:
program code for causing a drive apparatus including n optical pickups, n control means, each controlling a corresponding one of the n optical pickups, and communication means for allowing the n control means to communicate with one another to execute the step of:
controlling communication performed by the communication means so that, when a recording or reproducing operation is performed by the n optical pickups, information is exchanged among the n control means, and the n optical pickups are capable of cooperating.

13. A recording medium storing a computer-readable program for causing a drive apparatus including n optical pickups, n control means, each controlling a corresponding one of the n optical pickups, and communication means for allowing the n control means to communicate with one another to execute the step of:
controlling communication performed by the communication means so that, when a recording or reproducing operation is performed by the n optical pickups, information is exchanged among the n control means, and the n optical pickups are capable of cooperating.

14. A drive apparatus comprising:
n optical pickups;
n control units, each controlling a corresponding one of the n optical pickups; and
a communication unit configured to allow the n control units to communicate with one another.
